(19) United States
(12) Patent Application Publication
(10) Pub. No.: US 2026/0028044 A1
(43) Pub. Date: Jan. 29, 2026

(54) SYSTEM AND METHOD FOR RISK-AWARE BEHAVIORAL POLICY SELECTION BY AN AUTONOMOUS AGENT

(71) Applicant: May Mobility, Inc., Ann Arbor, MI (US)

(72) Inventors: Collin Johnson, Ann Arbor, MI (US); Jacob Crossman, Ann Arbor, MI (US); Edwin B. Olson, Ann Arbor, MI (US)

(73) Assignee: May Mobility, Inc., Ann Arbor, MI (US)

(21) Appl. No.: 19/269,394

(22) Filed: Jul. 15, 2025

Related U.S. Application Data
(60) Provisional application No. 63/675,606, filed on Jul. 25, 2024.

(51) Int. Cl. B60W 60/00; B60W 30/095; B60W 50/00

(52) U.S. Cl. CPC B60W 60/0011; B60W 30/0956; B60W 50/0097; B60W 60/0015; B60W 2554/4046

(57) ABSTRACT

A method for risk-aware policy assessment for an autonomous vehicle can include: collecting information associated with an environment of an ego vehicle; determining a set of policies; determining and assessing a set of risks encounterable (e.g., potentially encountered in the future) by the ego vehicle, and operating the ego vehicle based on the assessed risks. A system implementing the method can include a sensor suite, a computing system, a vehicle control system, and/or any other suitable set of components. In variants, the computing system can implement a multi-policy decision model, a risk model, an element selector, a policy generator, a fallback controller, policies (e.g., made up at least of policy elements, etc.), and/or any other suitable system components.

### CROSS-REFERENCE TO RELATED APPLICATIONS

This application claims the benefit of U.S. Provisional Application No. 63/675,606, filed 25 Jul. 2024, which is incorporated herein in its entirety by this reference.

This application is related to U.S. application Ser. No. 18/672,328, filed 23 May 2024, which is a continuation of U.S. application Ser. No. 18/538,312, filed 13 Dec. 2023, which claims the benefit of U.S. Provisional Application No. 63/432,137, filed 13 Dec. 2022, and U.S. Provisional Application No. 63/442,636, filed 1 Feb. 2023, each of which is incorporated in its entirety by this reference.

### TECHNICAL FIELD

This invention relates generally to the vehicle automation field, and more specifically to new and useful systems and methods for selecting behavioral policy by an autonomous agent in the vehicle automation field.

### BRIEF DESCRIPTION OF THE FIGURES

FIG. 1 is a schematic representation of a variant of the system.

FIG. 2 is a schematic representation of a variant of the system with an example policy generator.

FIG. 3 is a flowchart diagrammatic representation of a variant of the method.

FIG. 4 is a flowchart diagrammatic representation of a variant of the method.

FIG. 5 is an illustrative example of a variant of the system.

FIGS. 6A-6D are illustrative examples of variants of risk-policy element associations.

FIG. 7 is an illustrative example of a variant of the method.

FIG. 8 is an illustrative example of a variant of the method.

### DETAILED DESCRIPTION

The following description of the embodiments of the invention is not intended to limit the invention to these embodiments, but rather to enable any person skilled in the art to make and use this invention.

### 1. Overview.

A system (e.g., a system onboard an autonomous vehicle, etc.) can include a sensor suite 160, a computing system 170, a vehicle control system 180 and/or any other suitable components. In variants, the computing system 170 can include and/or operate in conjunction with a multi-policy decision model 101, a risk model 102, an element selector 103, a policy generator 104, a fallback controller 105, policies 110 (e.g., made up at least of policy elements 111, etc.), and/or any other suitable system components.

A method 200 for risk-aware policy assessment for an autonomous vehicle can include: collecting information associated with an environment of an ego vehicle S100; determining a set of policies S200; determining and assessing a set of risks encounterable (e.g., potentially encountered in the future) by the ego vehicle S300, and operating the ego vehicle based on the assessed risks S400. Additionally or alternatively, the method 200 can include any or all of: selecting a set of policy elements S210, generating a set of policies S220, performing a set of simulations S310, analyzing the simulation results S320, and/or any other processes. The method 200 can be performed with a system 100 as described below and/or any other suitable system.

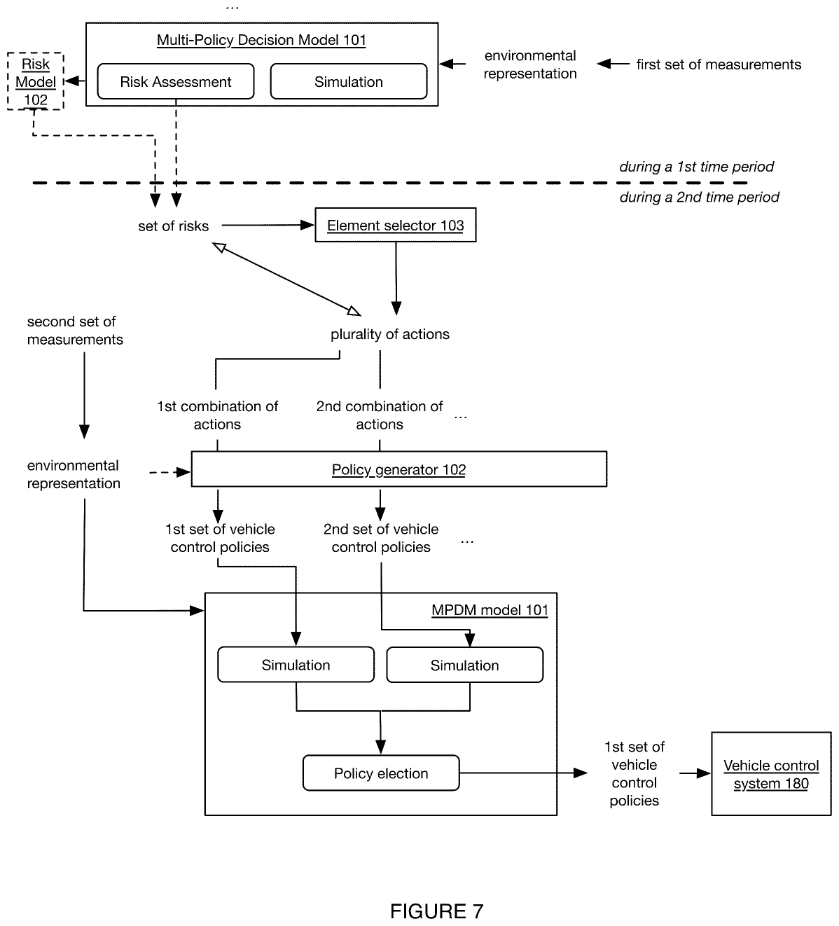

In a first illustrative example (e.g., as shown in FIG. 7), the method can include: at a first time period sampling a set of measurements of a set of environmental objects and determining risks associated with the set of environmental objects (e.g., during an MPDM simulation, etc.). Then during a second time period, the method can include, based on the risks, determining a plurality of policy elements (e.g., actions associated with evading and/or mitigating each risk), selecting a plurality of subsets of policy elements from the plurality of policy elements, and constructing from each subset a policy (e.g., including constraints of each policy elements, etc.). In this illustrative example, the plurality of subsets can include a first subset and a second subset. Then, the resultant first and second policies (from the first and second subset, respectively) can be simulated and evaluated, and the evaluations from each simulation (e.g., risk scores, etc.) can be compared in order to select a policy to implement. The selected policy can be implemented by a vehicle control system 180.

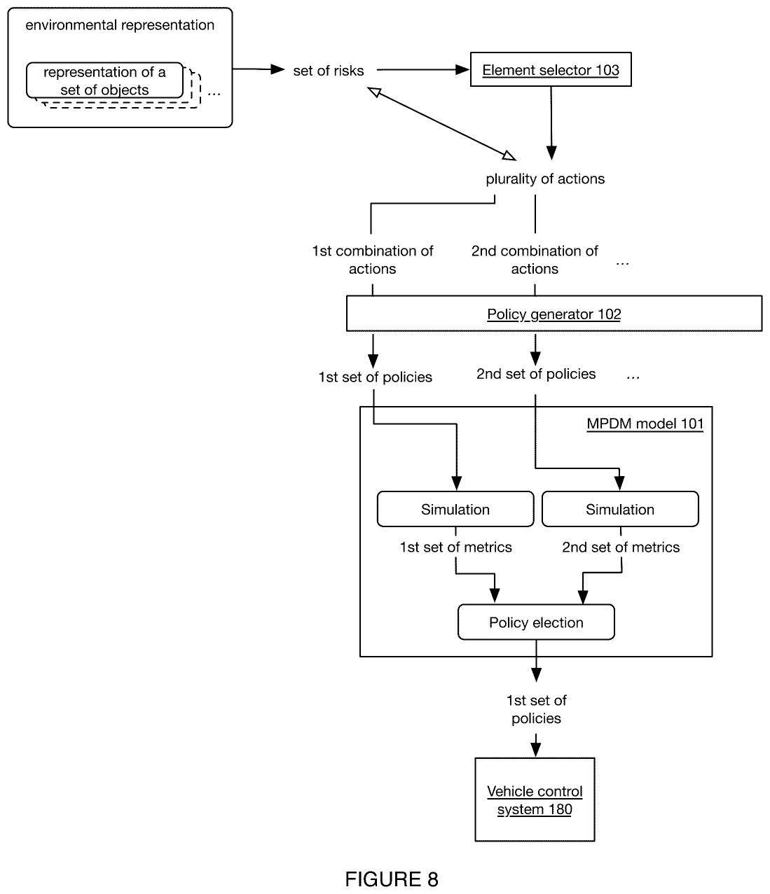

In a second illustrative example (e.g., as shown in FIG. 8), the method can include determining a set of risks, wherein each risk is associated with at least one object of a set of objects in an environment surrounding the vehicle. A plurality of actions (e.g., policy elements, etc.) can be determined based on the set of risks, and a pair of combinations of policy elements can be selected (e.g., wherein the policy elements of the first combination at least partially differ from the policy elements of the second combination). Each of the first combination and second combination can be converted into a policy (e.g., by combining policy elements of each, etc.), and the resultant first and second policies can be simulated. Metrics can be determined from each simulation, and the resultant metrics can be used to compare the first and second policies associated with the first and second simulation, respectively. Based on the comparison, a policy can be selected and implemented by the vehicle control system 180.

In the aforementioned illustrative examples, risks can be determined from an environmental representation from a previous timestep T−1, wherein the risks are used to narrow the action space from which policy elements are selected in the current timestep T. The metrics associated with each simulation can include determination (e.g., identification) of risks in the current timestep T, and the resultant risks can be used at a next timestep T+1 to narrow the action space during a next policy determination cycle.

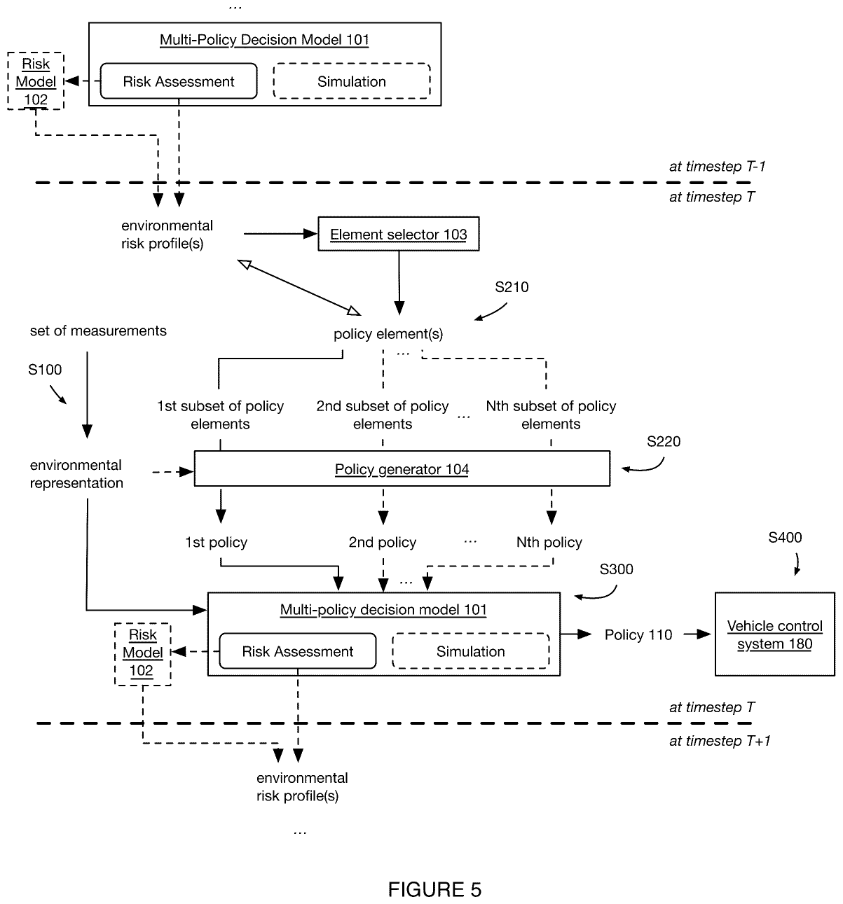

The autonomous agent may incorporate risk-awareness when determining and/or refining multiple types of policies during each election cycle (e.g., as shown in FIG. 5). The policies can include: generative policies (e.g., dynamically determined/generated based on prior risk analysis and most pertinent risks/constraints), context-based policies (e.g., deterministic and/or predetermined for a given driving context), and/or fallback/emergency policies (e.g., predetermined for given failure cases). In particular, risk-awareness can be used to generate and/or refine policies based on the most relevant risks and/or a reward function, which may frequently yield more favored elections (e.g., higher reward and/or lower cost actions) within the computing constraints of an election cycle (e.g., where the system returns an selected policy at the end of a finite and/or predefined election interval; with a frequency on the order of 5-10 Hz). The term ‘policy’ (and/or ‘policy candidate’ and/or ‘policy proposal’) as utilized herein preferably refers to a set of control laws (e.g., which can be simulated by MPDM and/or executed by the vehicle control system), but can additionally or alternatively refer to vehicle behaviors, actions, and/or any other suitable policies. For example, policies can be as described in U.S. application Ser. No. 16/514,624, filed 17 Jul. 2019, U.S. application Ser. No. 17/365,538, filed 1 Jul. 2021, and/or U.S. application Ser. No. 18/538,312, filed 13 Dec. 2023, each of which is incorporated herein in its entirety by this reference. However, the term policies can be otherwise suitably used/referenced herein.

The term “substantially” as utilized herein can mean: exactly, approximately, within a predetermined threshold or tolerance, and/or have any other suitable meaning.

### 2. Benefits.

Variations of the technology can afford several benefits and/or advantages.

First, variations of this technology can utilize forward simulations to account for the risks associated with future scenarios (equivalently referred to herein as futures) which may be encountered by an autonomous vehicle under a policy proposal. Additionally or alternatively, variants can enable a spectrum and/or multitude of risk classes, risk probabilities, and risk severities to be considered and assessed, rather than using only the most severe risks (e.g., collisions) in the vehicle's decision making, which can conventionally lead to ego vehicles exhibiting overly conservative, unpredictive, progress-hindering behaviors. In variants, the method involves considering multiple types of risks, such as, but not limited to: collision risk, conflict risk (e.g., the potential for the ego vehicle to be in a risk-heavy region, alternatively referred to as a ‘conflict zone’ herein, with an environmental agent, the potential for the ego vehicle to cross paths with another object, etc.), clearance risk (e.g., the potential for the ego vehicle to have insufficient spacing-either longitudinal or lateral-between the ego vehicle and another object, etc.), infrastructure risk (e.g., the potential for the ego vehicle to exceed a traversable physical bound of a roadway, such as a curb, etc.), and/or any other risks. Conflict zones can refer to a 2D or 3D spatiotemporal space in which a numerosity of risks (and/or risk metrics thereof) exceeds a threshold value, a predetermined space relative to a set of environmental features (e.g., an intersection box, etc.), and/or any other definition of high-risk spatial regions that warrant enhanced decision-making consideration. Additionally or alternatively, variants can additionally predict risk (e.g., a risk profile) that not only reflects the ego vehicle's future risk, but also (or alternatively) risk relating to objects in the ego's environment and their abilities to (1) mitigate risk from their perspective (e.g. braking to avoid the ego vehicle, braking to avoid another object, etc.) and (2) mitigate risk caused by environmental objects interacting with each other (e.g., when the ego is not involved at all). In examples, this is enabled though any or all of: the different types of simulations (e.g., simulations where ego is absent), the analysis of the likelihood of different predicted scenarios, the incorporation of prediction uncertainties in simulations when calculating risk metrics, and/or any other features of the system and/or method.

Second, variations can utilize prior simulations and prior risk analysis (e.g., from a prior election cycle) to generate and/or refine risk-aware policies which may be more likely to yield favorable evaluations within a current decision cycle (e.g., favorable cost function under updated risk analysis and simulation for a current election cycle). For instance, prior risk analysis can be used to construct policies (e.g., as a set of control laws) which address the most impactful risk factors in the future scenarios (e.g., relative to a cost function, reward, etc.), which can then be simulated to select the most favorable within the current environment (e.g., MPDM for a given election cycle), in view of any second order effects or emergent risk factors (e.g., as may arise from an intervening change in environment and/or policy proposals).

Third, variations of this technology can enable an autonomous vehicle to operate by performing behaviors more similar to behaviors exhibited by human drivers operating a manually driven vehicle. By selecting policy elements according to priority determined based on associated risks to the respective policy element (e.g., which risks which are more severe, more probable, closer in time, closer in space, more common in general, etc.) variations of the technology can “focus” on evaluating solutions which are likely to address the present risks in the scene (e.g., risk-aware policies, etc.). In variants, such focusing can reduce the action space (e.g., the space of possible policies which are considered, simulated, and evaluated, etc.) for the ego vehicle while maintaining a high probability of reaching an optimal or semi-optimal policy election. Such focusing can also improve the speed of policy election, enabling decision-making within election cycle constraints while maintaining risk coverage. In particular, risk-aware policies, determined based on elective cost functions and most relevant risks, may frequently yield more favorable policy elections (e.g., higher reward and/or lower cost actions; which align more closely with a navigation target) within the computing constraints of an election cycle and thus result in driving behaviors which more closely resemble ‘human’ driving behaviors. The benefit may be especially pronounced in complex futures, where the set of all possible control laws and policies scales exponentially with the number of environmental agents and agent interactions (e.g., where it may be infeasible to deterministically simulate every set of control laws by MPDM given computing constraints). In such circumstances, computing resource constraints may limit policy optimizations and can lead to conservative, less-favorable behaviors (e.g., which may ultimately increase the net risk across multiple election cycles and/or longer time horizons). However, optimizing around risk-aware policies can direct refinement towards key constraints and risk factors (e.g., before performing a risk analysis in the current election cycle; leveraging risk assessment from the n^{th} election cycle to reduce the search space of the n+1 cycle), thus resulting in more favorable behaviors for the same reward function.

Fourth, variations of the technology can enable human interpretation of autonomous vehicle decisions. Instead of acting as a “black-box” controller, each chosen policy can be associated with the risks and/or constraints (e.g., policy elements, etc.) used to generate the respective policy. This associated information can be described in human-understandable terms (e.g., “following cyclist”, “avoiding oncoming lane”, etc.) and traced back to labeled environmental risks associated with behavioral responses of the vehicle. Such explainability can improve regulatory confidence, passenger confidence, and/or post collision analysis, even when underlying risk models use machine learning approaches. In a variant, each policy can be traced back to specific environmental risks that triggered that policy election, enabling complete decision audit trails for safety analysis and regulatory compliance.

Fifth, variations of the technology can enable adaptive behavioral composition for complex scenarios. In variations of the technology where policy elements (e.g., primitives, etc.) are used, the system can compose novel policy proposals from a nuanced combination of multiple policy elements, enabling appropriate responses to previously-unseen combinations of environmental conditions. Furthermore, the system's usage of policy elements associated with risks can facilitate tunability of system sensitivity to risks of different types, proximities, probabilities, severities, and/or other attributes of an environment.

Sixth, variations of the technology can prevent behavioral oscillations through persistent risk memory across election cycles. By aggregating risks across all policy simulations rather than just the selected policy, the system can maintain awareness of risks even when temporarily addressed by policy selection. Such a memory mechanism can reduce the probability of the system ‘forgetting’ important risks and subsequently oscillating between different policies, leading to more stable and predictable driving patterns.

However, variations of the technology can additionally or alternately provide any other suitable benefits and/or advantages.

### 3. System.

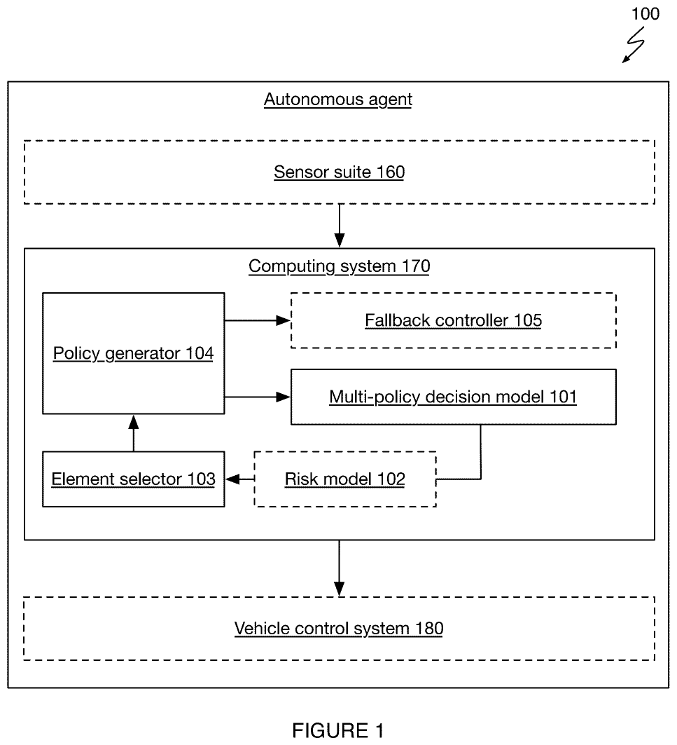

The system 100, an example of which is shown in FIG. 1, can include, a sensor suite 160, a computing system 170, a vehicle control system 180, and/or any other suitable set of components. In variants, the computing system 170 can implement a multi-policy decision model 101, a risk model 102, an element selector 103, a policy generator 104, a fallback controller 105, policies 110 (e.g., made up at least of policy elements 111, etc.), and/or any other suitable system components. However, the system 100 can additionally or alternatively include any other suitable set of components. The system can function to select a policy 110 for the vehicle based on a set of future simulations and risk assessment. Additionally or alternatively, the system can function to determine (risk-aware) policies 110 based on a prior risk assessment(s). Additionally or alternatively, the system can function to execute the method 200 and/or can perform any other suitable function(s).

The system 100 can include and/or interface with an ego vehicle (equivalently referred to herein as an autonomous vehicle, autonomous agent, ego agent, agent, etc.) and a set of computing subsystems thereof (equivalently referred to herein as a set of computers) and/or processing subsystems (equivalently referred to herein as a set of processors), which function to implement any or all of the processes of the method. Additionally or alternatively, the system 100 can include and/or interface with one or more sets of sensors (e.g., onboard the ego agent, onboard a set of infrastructure devices, etc.), a simulation subsystem including a set of simulators (e.g., executable at one or more computing subsystems), a set of infrastructure devices, a teleoperator platform, a tracker, a positioning system, a guidance system, a communication interface, and/or any other components.

The system can optionally include or interface with a sensor suite 160, which functions to monitor vehicle state parameters and/or an environment of the vehicle to be used as inputs for vehicle control (e.g., autonomous vehicle control). The sensor suite can include: perception sensors (e.g., motion sensors, time of flight sensors, cameras, Radar, Lidar, etc.), environmental sensors (e.g., cameras, temperature, wind speed/direction, barometers, air flow meters), guidance sensors (e.g., Lidar, Radar, cameras, etc.), cameras (e.g., CCD, CMOS, multispectral, visual range, hyperspectral, stereoscopic, etc.), spatial sensors, internal sensors (e.g., accelerometers, magnetometer, gyroscopes, IMU, INS, temperature, voltage/current sensors, etc.), inertial sensors (e.g., IMU, accelerometers, magnetometer, gyroscopes, etc.), diagnostic sensors (e.g., cooling sensors such as: pressure, flow-rate, temperature, etc.; BMS sensors; tractor/trailer inter-connection sensors or passthrough monitoring, etc.), location sensors (e.g., GPS, GNSS, triangulation, trilateration, etc.), wheel encoders, proximity sensors, OBD-port, and/or any other suitable sensors. The computing system preferably receives sensor inputs from the sensor(s) of the sensor suite, but the inputs can additionally or alternatively include historical information associated with the ego agent (e.g., historical state estimates of the ego agent) and/or environmental agents (e.g., historical state estimates for the environmental agents), sensor inputs from sensor systems offboard the ego agent (e.g., onboard other ego agents or environmental agents, onboard a set of infrastructure devices and/or roadside units, etc.), environmental representation (e.g., determined based on current and/or historical sensor data), and/or any other inputs or information. However, the system can include any other suitable sensor suite.

The system can optionally include and/or interface with a vehicle control system 180 including vehicle modules/components which function to effect vehicle motion based on the operational instructions (e.g., plans and/or trajectories) generated by policies (e.g., controllers, etc.) executed by the computing system. Additionally or alternatively, the vehicle control system can include, interface with, and/or communicate with any or all of a set electronic modules of the ego vehicle, such as but not limited to, any or all of: component drivers, electronic control units (ECUs), telematic control units (TCUs), transmission control modules (TCMs), antilock braking system (ABS) control module, and/or any other suitable control subsystems and/or modules. In preferred variations, the vehicle control system includes, interfaces with, and/or implements a drive-by-wire system of the vehicle. Additionally or alternatively, the vehicle can be operated in accordance with the actuation of one or more mechanical components, and/or be otherwise implemented. However, the system can include or be used with any other suitable vehicle control system; or can be otherwise suitably implemented. For example, the system can be implemented in conjunction with the vehicle control system(s) and/or fallback controller as described in U.S. application Ser. No. 17/550,461, filed 14 Dec. 2021, which is incorporated herein in its entirety by this reference.

The computing system 170 preferably functions to determine vehicle controls based on an environmental representation (e.g., based on inputs from the sensor suite, etc.). Additionally or alternatively, the computing system can function to process inputs from the sensor suite to determine and/or execute a policy for each election cycle (e.g., with a frequency of about 10 Hz) of the ego vehicle, to determine vehicle controls to be executed by the vehicle control system to facilitate autonomous operation via Block S400. However, the computing system can be otherwise configured.

The computing system can include a set of models, which can include: a multi-policy decision-making model (an MPDM model) 101, a risk model 102, an element selector 103, a policy generator 104, an optional fallback controller, and/or any other suitable models.

The risk model 102 functions to determine a risk profile associated with a scene. Inputs to the risk model can include simulation results from policy rollouts (e.g., from S300 of a previous election cycle performed at timestep T−1), risk data from multiple simulated policies, environmental representation data, sensor measurements, and/or any other suitable information. Outputs of the risk model can include a risk profile (e.g., aggregated risk data, risk-to-agent mappings, temporal risk information, and/or prioritization data, etc.) and/or any other suitable information.

In a first variant, the risk model 102 can operate on outputs and/or intermediate values determined during policy simulation (e.g., in S300 of a previous timestep T−1, etc.). In this variant, the risk model preferably aggregates risks across multiple different simulations (e.g., including simulations of policies that were not elected to be implemented by the ego vehicle, etc.) to create a risk memory that prevents risk forgetting between election cycles but can alternatively use risk associated with a single simulation. The risk model can aggregate risks from multiple different election cycles (e.g., from previous iterations of the method, etc.) to maintain persistence of unresolved risks and prevent oscillatory decision-making behaviors; alternatively, the risk model can determine risks associated with the current election cycle only. In an example, a set of risks of a risk profile are aggregated from multiple simulation cycles from a same election cycle, each including multiple simulations (e.g., each simulation representing different policies for the ego vehicle and/or environmental agents in the scene, etc.). In a second variant, the risk model determines risk independently of simulation and/or simulation results determined therefrom. In this variant, risk is determined for a scene based on sensor measurements, an environmental representation of the scene, and/or any other suitable information without relying on forward simulation data. However, the risk model can alternatively operate on any other suitable inputs. The risk model can output a risk profile and/or any other suitable information.

The risk model can leverage a trained model, a set of rules, a lookup table, and/or any other suitable evaluation mechanisms to estimate risks and/or metrics thereof. The risk model 102 is preferably executed by the computing system 170 but can additionally or alternatively be implemented by any other suitable computing system or hardware configuration. However, the risk model 102 can be otherwise configured.

Risks, as assessed by the system 100, can refer to risks encounterable by the ego vehicle in the scene. Risks can be associated with a particular environmental object(s) (e.g., environmental agent, static environmental feature, lane boundary feature, etc.), locations, times, severity levels, probabilities, weights, and/or any other suitable information. In a first example, a single risk can be associated with multiple environmental objects (e.g., 1:N; in which each environmental object each poses the same risk, where the environmental objects cooperatively define a risk, such as a clearance risk between two close vehicles, etc.). In a second example, multiple risks can be associated with a single environmental object (e.g., N:1; in which the ego vehicle is at risk of conflicting and/or colliding with an environmental object, etc.). In a third example, a single risk can be associated with a single environmental object (e.g., 1:1). However, risks and objects can be associated in any other suitable ratio. Risk classes can include collision risks (e.g., potential impacts with other environmental objects), conflict risks (e.g., time or space conflicts where multiple environmental objects may occupy the same region), clearance risks (e.g., insufficient lateral or longitudinal spacing between the ego vehicle and environmental objects), and infrastructure risks (e.g., risks associated with road geometry, traffic control devices, or lane boundaries). Each risk can be represented within a risk profile by one or more risk metrics including: the risk class, a risk severity metric (e.g., measured in energy units such as kinetic energy or modified kinetic energy, such that the risk severity metric includes an estimated kinetic energy associated with avoiding and/or mitigating the risk, etc.), a risk probability metric, (e.g., a value between 0 and 1 indicating the likelihood of the risk, etc.), a risk relevance metric (e.g., a value between 0 and 1 indicating the importance of the risk given a current objective of the ego vehicle, etc.), a risk persistence metric (e.g., scoring risks according to their appearing across multiple simulations in parallel and/or in multiple subsequent election cycles, etc.), a temporal component (e.g., time until the risk may occur within the simulation horizon), a spatial component (e.g., location where the risk is predicted to manifest), and/or any other risk information and/or parameters.

In examples, for collision risks, parameters can include: impact velocity (e.g., relative velocity at predicted impact time, etc.), impact angle (e.g., a front, side, and/or rear impact classification, a numerical value, etc.), impact energy (e.g., kinetic energy transfer, etc.), an object softness factor (e.g., 1.0 for vehicles, 2.5 for pedestrians, 1.5 for cyclists), a minimum time to collision (e.g., seconds until impact if no preventative action taken), and/or any other suitable collision risk information.

In examples, for conflict risks, parameters can include: conflict zone dimensions (e.g., overlapping area in square meters), conflict zone coordinates, time gap at conflict point (e.g., temporal separation between ego and other agent occupying the conflict zone), crossing angle (e.g., to differentiate perpendicular, merging, and/or head-on conflicts), conflict duration (e.g., time window during which both agents may occupy the same space, etc.) and/or any other suitable conflict risk information.

In examples, for clearance risks, parameters can include: minimum lateral clearance (e.g., closest lateral distance in meters), minimum longitudinal clearance (e.g., following distance or headway in meters), clearance duration (e.g., time period of insufficient clearance), relative speed differential (e.g., speed difference affecting required clearance), clearance violation severity (e.g., percentage below safe threshold), and/or any other suitable clearance risk information.

In examples, for infrastructure risks, parameters can include: curve radius (e.g., minimum turning radius in meters), maximum safe speed (e.g., speed limit for curve negotiation), lane boundary type (e.g., solid line, dashed line, physical barrier), boundary crossing severity (e.g., minor encroachment vs. full departure), road surface condition factor (e.g., friction coefficient modifier), and/or any other suitable infrastructure risk information.

A risk profile can be or include a data structure representing the set of risks in the scene encounterable by the vehicle. The risk profile is preferably determined by a risk model based on policy simulations performed by the multi-policy decision-making model 101 but can alternatively be determined by the multi-policy decision-making model 101 (e.g., where the MPDM model 101 uses risk directly to evaluate simulated policies, etc.) or can be determined by any other suitable system component. The risk profile can include only risks identified at the previous timestep (e.g., at timestep T−1) but can alternatively include risks identified at prior timesteps. In an example, a risk that was identified at a prior timestep but not the immediately-previous timestep is included in the risk profile (e.g., optionally with some decay associated with the time since the election cycle in which risk was predicted) in addition to another risk that was identified at the prior timestep. However, the set of risks can otherwise include different risks each determined at different timesteps. In a specific example, the decay can be a function of both the time since the election cycle in which the risk was predicted and the length of the predicted time horizon between prediction and occurrence. In another example, the risk profile includes multiple different risks determined during different election cycles.

In a first variant, the risk profile can include an object-risk mapping that associates environmental objects with corresponding risk data (e.g., including the risk metrics described above, etc.). In a second variant, the risk profile can include a coordinate-risk mapping that associates coordinates in 2D or 3D space with risks and/or risk metrics thereof occurring at each respective coordinate set. In an example of this variant, the risk profile can be a heatmap. In a third variant, the risk profile can include a temporal-risk mapping that organizes risks according to their predicted occurrence times within the simulation horizon, enabling time-based risk queries and prioritization. In a fourth variant, the risk profile can include a hierarchical structure that combines multiple mapping types, such as a primary object-risk mapping with nested spatial and temporal sub-mappings for each environmental object. In a fifth variant, the risk profile can include a graph structure where nodes represent environmental objects or spatial locations and edges represent risk relationships or dependencies between them. Additionally or alternatively, the risk profile can include indexing structures (e.g., hash tables, binary trees, etc.) that enable efficient lookup and retrieval of risk data by object identifier, risk class, spatial region, temporal window, and/or any other suitable criteria. The risk profile can additionally or alternatively include a lookup table, a database, an array structure, a linked list, a hash map, and/or any other suitable data format that enables efficient storage, retrieval, and updating of risk information between election cycles. However, the risk profile can be otherwise defined.

The element selector 103 functions to determine a set of policy elements based on risks within the risk profile (e.g., perform S210, etc.). Inputs to the element selector can include a risk profile (e.g., generated by the risk model 102, determined by the multi-policy decision-making model, etc.), an environmental representation, and/or any other suitable information. Outputs of the element selector can include a set of individual policy elements (e.g., primitives, etc.) that correspond to identified risks in the scene, wherein each policy element is selected to address one or more specific risks. The element selector preferably outputs individual policy elements (e.g., primitives, etc.) without performing combination logic or prioritization but can additionally or alternatively prioritize elements according to associated risk metrics and rules associated therewith. The element selector 103 is preferably executed by the computing system 170 but can additionally or alternatively be implemented by any other suitable computing system or hardware configuration. However, the element selector 103 can be otherwise defined.

Policy elements 111 function to represent considerations for vehicle planning during policy formation. Given the complexity of a typical scene (e.g., including different types of objects which need to be avoided differently, constructing a policy from policy elements can enable discrete, scene-specific and/or risk-specific policies to be evaluated (e.g., in S300) and implemented (e.g., in S400). In variants, policy elements can represent actions, behaviors, limitations, and/or any other suitable type of decision that addresses specific risks or environmental objects in the driving environment. Policy elements can include semantic instructions (e.g., “follow agent”, “avoid debris”, “overtake agent”), kinematic parameters in any/all of X/Y/Z coordinates (e.g., distance between the ego vehicle and an object in the environment, etc.), temporal parameters, object identifiers (e.g., to pair with semantic instructions and/or parametric values, etc.), object class identifiers (e.g., such that a policy elements can refer to all objects of a particular type, etc.), and/or any other suitable types of data. In an example, policy elements are “primitives” (e.g., action primitives, behavioral primitives, etc.) that represent fundamental, atomic behaviors which can be combined to form more complex policies-such as lateral primitives (e.g., “overtake moving agent”, “pass stationary object”, “restrict lane boundary”) and longitudinal primitives (e.g., “follow agent”, “yield for agent”, “stop at location”) that directly correspond to specific risk mitigation strategies identified during risk assessment.

In a first variant, a policy element can include a set of constraints associated with an environmental object (e.g., keep X meters of following distance between the ego vehicle and environmental object Z, etc.). In a second variant, a policy element can include a controller or control law that defines how the ego vehicle should behave with respect to an environmental object or spatial region (e.g., an adaptive cruise control law for following behavior, a lateral avoidance controller for passing maneuvers, etc.). In a third variant, a policy element can include a cost function that influences path generation by creating virtual attractive or repulsive forces relative to environmental objects and/or spatial regions in the environment (e.g., a lateral virtual force that pushes the ego vehicle away from a parked vehicle, a cost function that penalizes proximity to oncoming traffic, etc.). In a fourth variant, a policy element can include a target selector that designates which environmental object or spatial location the ego vehicle should orient its behavior toward (e.g., selecting a lead vehicle for following, designating a stopping point for yielding behavior, etc.). The aforementioned variants are non-exclusive with one another (and preferably are combined to form policy elements which include multiple different types of information).

In variants where policy elements refer to environmental objects (e.g., an environmental agent to be followed, a static environmental object to maintain a lateral gap with, etc.), policy elements can include parameters (e.g., distance parameters, time parameters, function-defined parameters, etc.), references to specific environmental objects (e.g., “object X”, etc.), references to environmental objects in specific positions (e.g., “object in front of the ego vehicle”, etc.) and/or semantic labels (e.g., semantic action identifiers) or behavioral descriptors that qualitatively define the intended action (e.g., “follow agent A,” “pass stationary object B on the left,” “yield for crossing pedestrian C,” etc.) wherein the specific implementation details are determined by downstream path generation and control systems. However, policy elements can include and/or be associated with any other suitable types of rules. Policy elements are preferably not associated with specific trajectories (e.g., paths in 2D or 3D space, etc.) but can alternatively be associated with specific trajectories.

Policy elements can include lateral policy elements and longitudinal policy elements, but can additionally or alternatively include policy elements of other suitable types.

Lateral policy elements can include: overtaking elements that direct the ego vehicle to pass moving environmental objects; passing elements that direct the ego vehicle to navigate around stationary environmental objects; lane boundary restriction elements that enforce stricter adherence to lane boundaries to avoid encroachment; lane boundary relaxation elements that permit crossing or approaching lane boundaries when necessary for safe navigation; lateral acceleration modification elements that adjust the aggressiveness of lateral maneuvering; avoidance elements that direct the ego vehicle away from specific environmental objects or spatial regions; and/or any other suitable lateral policy elements.

Longitudinal policy elements can include: following elements that attach the ego vehicle to a target environmental object using adaptive cruise control or similar following behavior; yielding elements that direct the ego vehicle to wait until a specified environmental object has cleared the ego vehicle's intended path; stopping elements that direct the ego vehicle to stop at a designated location or before a specified condition; speed modification elements that adjust target velocity; late crosser elements (equivalently referred to as time-to-collision elements) that provide reactive responses to environmental objects that begin moving unexpectedly; and clearance control elements that modulate vehicle speed based on lateral proximity to environmental objects.

However, policy elements can be alternatively defined.

Policies 110 function to define vehicle behavior and trajectories for autonomous operation of the ego vehicle. A policy can include a controller or set of controllers that, based on an environmental representation of the environment surrounding the ego vehicle, generates specific vehicle commands and/or trajectories. In variants, a policy can include a reference path that defines the spatial trajectory the ego vehicle should follow, wherein the reference path can be generated based on longitudinal and/or lateral policy elements and environmental constraints. Additionally or alternatively, a policy can include a set of control laws, mathematical functions, and/or algorithms that map current vehicle state and environmental conditions to desired vehicle actions.

Policies are preferably determined by the policy generator 104 but can alternatively be determined by any other suitable system component. Policies are preferably determined in S220 but can alternatively be determined in any other suitable timestep (e.g., extracted from memory after being determined at a previous timestep, etc.).

However, policies 110 can be otherwise defined.

The policy generator 104 functions to generate policies for simulation during S300 and/or execution during S400. Inputs to the policy generator can include a set of selected policy elements (e.g., determined by the element selector 103 based on a mapping with risks within a risk profile, etc.), an environmental representation, a set of navigation goals or objectives, vehicle state information, and/or any other suitable information. Outputs of the policy generator can include a set of policy proposals (e.g., multiple policy options for evaluation, a single selected policy, etc.) and/or any other suitable information. Preferably, the policy generator determines each policy proposal based on a combination of one or more policy elements that are compatible and non-conflicting. Each output policy can include control laws, reference paths, target selections, behavioral parameters, and/or other control specifications that define how the ego vehicle should behave in the current environmental conditions. The policy generator is preferably executed by the computing system 170 but can additionally or alternatively be implemented by any other suitable computing system or hardware configuration. However, the policy generator can be otherwise configured.

The multi-policy decision-making model 101 functions to simulate and evaluate different policies (e.g., perform S300 and processes thereof, etc.) In variants, the multi-policy decision making model 101 can be or include the “simulator module,” “multi-policy decision-making task block” and/or the “multi-policy decision-making module” of U.S. application Ser. No. 18/538,312, filed 13 Dec. 2023, which is incorporated herein in its entirety by this reference. Inputs to the multi-policy decision-making model can include a set of policy proposals, an environmental representation, and/or any other suitable information. Outputs of the multi-policy decision-making model can include a selected policy, a set of scores evaluating aggregated risk associated with each policy (e.g., wherein risk is aggregated over multiple timesteps, multiple risks in a scene, etc.), and/or any other suitable information. The multi-policy decision-making model 101 is preferably executed by the computing system 170 but can additionally or alternatively be implemented by any other suitable computing system or hardware configuration. However, multi-policy decision-making model 101 can be otherwise configured.

The models (e.g., multi-policy decision-making model 101, the risk model 102, the element selector 103, the policy generator 104, policies 110, etc.) can include classical or traditional approaches, machine learning approaches, and/or be otherwise configured. The models can include regression (e.g., linear regression, non-linear regression, logistic regression, etc.), decision tree, LSA, clustering, association rules, dimensionality reduction (e.g., PCA, t-SNE, LDA, etc.), neural networks (e.g., CNN, DNN, CAN, LSTM, RNN, encoders, decoders, deep learning models, transformers, etc.), ensemble methods, optimization methods, classification, rules, heuristics, equations (e.g., weighted equations, etc.), selection (e.g., from a library), regularization methods (e.g., ridge regression), Bayesian methods (e.g., Naïve Bayes, Markov), instance-based methods (e.g., nearest neighbor), kernel methods, support vectors (e.g., SVM, SVC, etc.), statistical methods (e.g., probability), comparison methods (e.g., matching, distance metrics, thresholds, etc.), deterministics, genetic programs, and/or any other suitable model. The models can include (e.g., be constructed using) a set of input layers, output layers, and hidden layers (e.g., connected in series, such as in a feed forward network; connected with a feedback loop between the output and the input, such as in a recurrent neural network; etc.; wherein the layer weights and/or connections can be learned through training); a set of connected convolution layers (e.g., in a CNN); a set of self-attention layers; and/or have any other suitable architecture.

Models can be trained, learned, fit, predetermined, and/or can be otherwise determined. The models can be trained or learned using: supervised learning, unsupervised learning, self-supervised learning, semi-supervised learning (e.g., positive-unlabeled learning), reinforcement learning, transfer learning, Bayesian optimization, fitting, interpolation and/or approximation (e.g., using gaussian processes), backpropagation, and/or otherwise generated. The models can be learned or trained on: labeled data (e.g., data labeled with the target label), unlabeled data, positive training sets (e.g., a set of data with true positive labels, negative training sets (e.g., a set of data with true negative labels), and/or any other suitable set of data.

Any model can optionally be validated, verified, reinforced, calibrated, or otherwise updated based on newly received, up-to-date measurements; past measurements recorded during the operating session; historic measurements recorded during past operating sessions; or be updated based on any other suitable data.

Any model can optionally be run or updated: once; at a predetermined frequency; every time the method is performed; every time an unanticipated measurement value is received; or at any other suitable frequency. Any model can optionally be run or updated: in response to determination of an actual result differing from an expected result; or at any other suitable frequency. Any model can optionally be run or updated concurrently with one or more other models, serially, at varying frequencies, or at any other suitable time.

However, the computing system can use any other suitable set of models.

However, the system can include any other suitable elements.

### 4. Method.

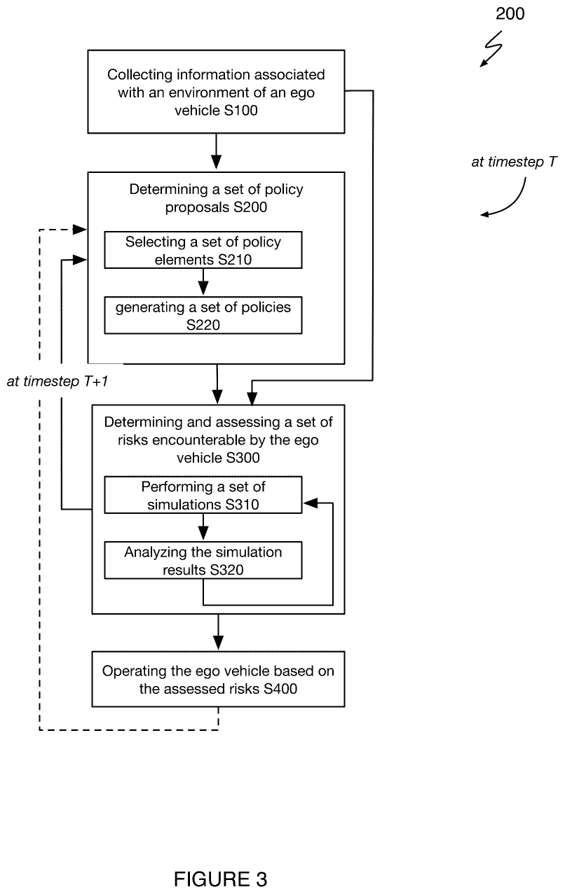

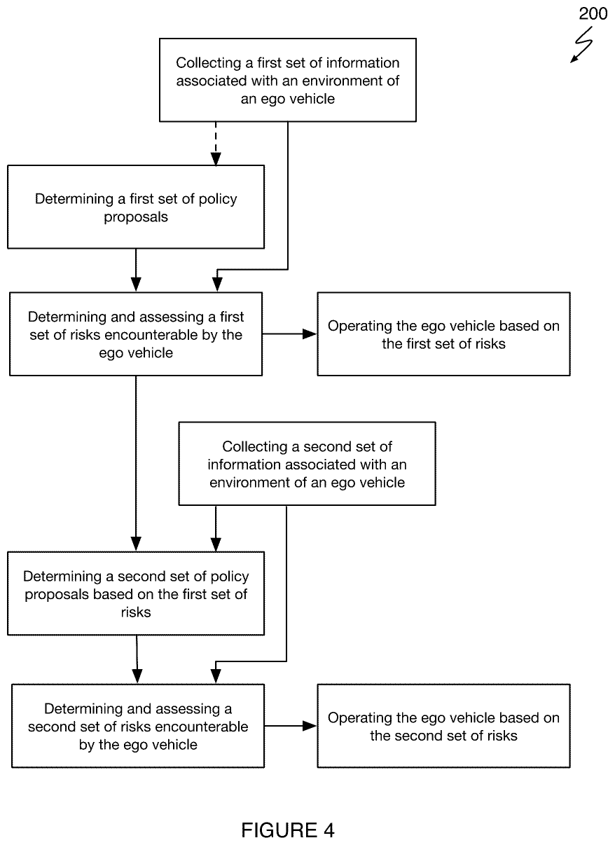

A method 200 for risk-aware policy assessment for an autonomous vehicle, an example of which is shown in FIG. 3, can include: collecting information associated with an environment of an ego vehicle S100; determining a set of policies S200; determining and assessing a set of risks encounterable (e.g., potentially encountered in the future) by the ego vehicle S300, operating the ego vehicle based on the assessed risks S400; and/or any other suitable elements. Additionally or alternatively, the method can include any or all of: selecting a set of policy elements S210, generating a set of policies S220, performing a set of simulations S310, analyzing the simulation results S320, and/or any other processes. The method 200 can be performed with a system 100 as described above and/or any other suitable system. In variants, the method can include or be used in conjunction with the risk assessment method(s) and/or element(s) as described in U.S. application Ser. No. 18/538,312, filed 13 Dec. 2023, which is incorporated herein in its entirety by this reference. An example of the method 200 is shown in FIG. 4.

The method 200 preferably functions to determine (risk-aware) policies based on prior risk analysis and/or leverage risk-aware policy assessment to facilitate evaluation of more favorable policy elections (e.g., relative to a given reward and/or cost function). The risks (equivalently referred to herein as hazards and/or hazardous events) encounterable by an autonomous vehicle preferably refer to potentially hazardous scenarios which are detectable by the autonomous vehicle, such as potentially hazardous events (e.g., collisions, potential collisions, etc.) that are detected based on data collected via the sensor suite vehicle and processed at prediction and/or planning subsystems.

The method 200 can optionally be configured to interface with a multi-policy decision-making process (e.g., multi-policy decision-making task block of a computer-readable medium; MPDM) of the ego agent and any associated components (e.g., computers, processors, software modules, etc.), but can additionally or alternatively interface with any other decision-making processes. In a preferred set of variations, for instance, a multi-policy decision-making model 101 of the computing system 170 (e.g., onboard computing system) includes a simulator module (or similar machine or system) (e.g., simulator task block of a computer-readable medium) that functions to predict (e.g., estimate) the effects of future (i.e., steps forward in time) behavioral policies (operations or actions) implemented at the ego agent and optionally those at each of the set environmental objects (e.g., other vehicles in an environment of the ego agent) and/or objects (e.g., pedestrians) identified in an operating environment of the ego agent. The simulations can be based on a current state of each agent (e.g., the current hypotheses) and/or historical actions or historical behaviors of each of the agents derived from the historical data buffer (preferably including data up to a present moment). The simulations can provide data relating to interactions (e.g., relative positions, relative velocities, relative accelerations, etc.) between projected behavioral policies of each environmental object (e.g., simulated environmental agents within the scene) and the one or more potential behavioral policies that may be executed by the autonomous agent. The data from the simulations can be used to determine (e.g., calculate) any number of metrics, which can individually and/or collectively function to assess any or all of: the potential impact of the ego agent on any or all of the environmental agents when executing a certain policy, the risk of executing a certain policy (e.g., collision risk), the extent to which executing a certain policy progresses the ego agent toward a certain goal, and/or determining any other metrics involved in selecting a policy for the ego agent to implement. The multi-policy decision-making process can additionally or alternatively include and/or interface with any other processes, such as, but not limited to, any or all of the processes described in: U.S. application Ser. No. 16/514,624, filed 17 Jul. 2019; U.S. application Ser. No. 17/365,538, filed 1 Jul. 2021; and/or U.S. application Ser. No. 18/538,312, filed 13 Dec. 2023, each of which is incorporated in its entirety by this reference, or any other suitable processes performed in any suitable order.

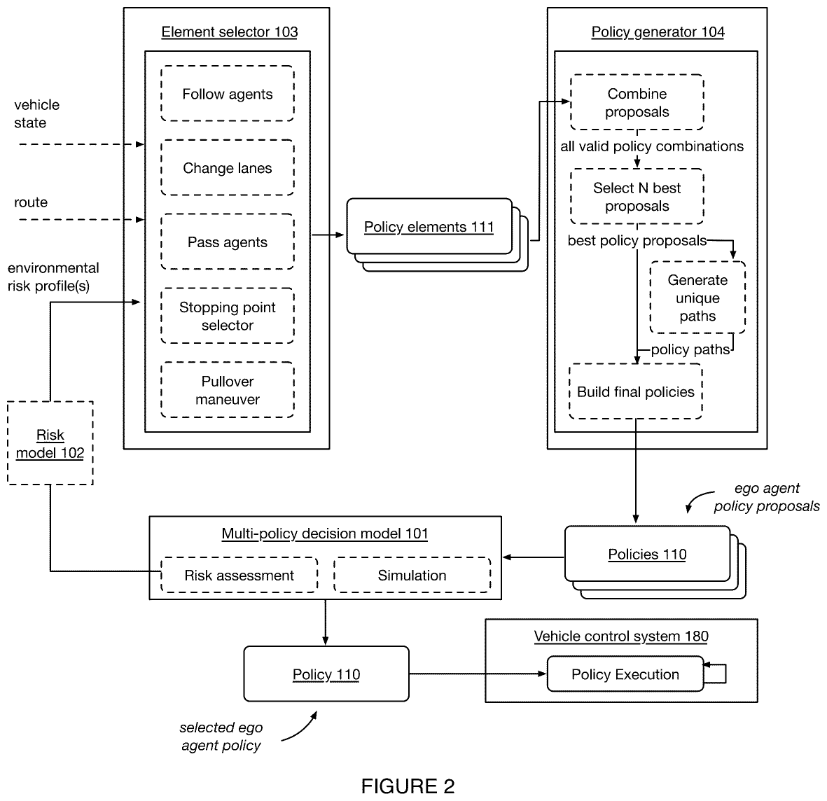

In a preferred set of variants, for instance, the method and/or simulation (and risk assessment) is performed for each of a set of policy proposals under consideration by the autonomous vehicle (e.g., as determined by S200), where a risk metric and/or risk profile is generated for each policy proposal, where a particular policy is selected based on the metric(s) and/or profile(s). Selecting this policy, for instance, can be based on any or all of: a time in the future at which a maximum risk is predicted to occur (e.g., how far in the future) in the policy, a total level of risk associated with the policy (e.g., integrating over a risk curve), a magnitude of the risk (e.g., magnitude of maximum point in risk profile), an average risk, a median risk, and/or any other metrics. In some examples, for instance, a policy is selected based on both the value of the risk magnitude and the time in the future at which the risk is predicted to occur. The risk metric(s) can dynamically inform which policy proposals are considered in future election cycles, and/or can be used to generate/refine risk-aware policies in future election cycles (e.g., an example is shown in FIG. 2). In some examples, for instance, at least a portion of the policies evaluated within an election cycle are determined based on the (environmental) risks and/or profiles produced in a prior (e.g., immediately preceding) election cycle. For example, the risks represented within a risk profile can be used to select policy elements (e.g., rules, constraints, controllers, etc.) based on a predetermined mapping between risk classes and policy element types, and the policy elements can be combined to generate a policy proposal. Additionally or alternatively, the method 200 can include and/or otherwise interface with any other decision-making processes and/or models of the computing system.

4.1 Method—Collecting Information Associated with an Environment of an Ego Vehicle S100

The method can include collecting information associated with an environment of an ego vehicle S100, which functions to receive information with which to assess the ego vehicle's environment and inform the performance of any or all of the remaining processes of the method 200.

S100 is preferably performed continuously (e.g., at a predetermined frequency, at irregular intervals, etc.) throughout operation of the ego agent, but can additionally or alternatively be performed: according to (e.g., at each initiation of, during each of, etc.) a cycle associated with the ego agent, such as any or all of: an election cycle (e.g., 5 Hz, 10 Hz, etc.; between 5-20 Hz cycle, etc.) associated with the ego agent (e.g., in which the ego agent selects a new policy), a perception cycle associated with the ego agent, a planner cycle (e.g., 30 Hz, between 20-40 Hz, occurring more frequently than the election cycle, etc.) associated with the ego agent; in response to a trigger (e.g., a request, an initiation of a new cycle, etc.); and/or at any other times during the method 200.

The inputs preferably include sensor inputs received from a sensor suite (e.g., cameras, Lidars, Radars, motion sensors [e.g., accelerometers, gyroscopes, etc.], outputs of an OBD-port, etc.], location sensors [e.g., GPS sensor], etc.) onboard the ego agent, but can additionally or alternatively include historical information associated with the ego agent (e.g., historical state estimates of the ego agent) and/or environmental objects (e.g., historical state estimates for environmental agents, states of static environmental objects, etc.), sensor inputs from sensor systems offboard the ego agent (e.g., onboard other ego agents or environmental agents, onboard a set of infrastructure devices and/or roadside units, etc.), information and/or any other inputs.

The inputs preferably include information which characterizes the environment of the ego agent (e.g., an environmental representation, etc.), which can include: other environmental objects (e.g., environmental agents such as vehicles, pedestrians, etc.; as well as stationary environmental objects, such as signs, curbs, lane boundaries, trees, etc.) proximal to the ego agent (e.g., within field-of-view of its sensors, within a predetermined distance, etc.); environmental features of the ego agent's surroundings (e.g., to be referenced in a map, to locate the ego agent, etc.); and/or any other information. In some variations, for instance, the set of inputs includes information (e.g., from sensors onboard the ego agent, from sensors in an environment of the ego agent, from sensors onboard the objects, etc.) that characterizes any or all of: the location, type/class (e.g., vehicle vs. pedestrian, etc.), and/or motion of environmental objects being tracked by the system 100, where environmental objects can include static objects (e.g., parked or otherwise non-moving vehicles, stationary pedestrians, etc.), dynamic objects (e.g., environmental agents such as moving vehicles, walking or running pedestrians, bikers, etc.), or any other objects or combinations of objects. Additionally or alternatively, the set of inputs can include information that characterizes (e.g., locates, identifies, etc.) features of the road and/or other landmarks/infrastructure (e.g., where lane lines are, where the edges of the road are, where traffic signals are and which type they are, where agents are relative to these landmarks, etc.), such that the ego agent can locate itself within its environment (e.g., in order to reference a map), and/or any other information.

The inputs further preferably include information associated with the ego agent, which herein refers to the vehicle being operated during the method. This can include information which characterizes the location of the ego agent (e.g., relative to the world, relative to one or more maps, relative to other objects, etc.), motion (e.g., speed, acceleration, etc.) of the ego agent, orientation of the ego agent (e.g., heading angle), a performance and/or health of the ego agent and any of its subsystems (e.g., health of sensors, health of computing system, etc.), and/or any other information.

Any or all of the aforementioned information can additionally or alternatively be determined for environmental objects.

Additionally or alternatively, S100 can include any other processes and/or involve the collection of any other suitable information.

In a preferred set of variations, S100 includes collecting sensor data which is used to perform the simulations described in S310.

### 4.2 Method—Determining a Set of Policy Proposals S200

The method can include determining a set of policy proposals S200 which can be simulated and/or assessed for risk in S300 (e.g., which may be used to select a policy for autonomous operation via S400 at each election cycle). Additionally, S200 can incorporate (environmental) risk awareness from a prior election cycle (and/or prior instance of S300) to facilitate refinement around risks most impacting policy selection (i.e., based on impact on the reward functions in S400). For example, S200 can propagate risk-awareness across multiple election intervals, thus enabling a degree of refinement across longer time scales, though each individual election can be based on deterministic simulation within a single election cycle (e.g., where compute time is bounded within an election interval). S200 can include selecting a set of policy elements S210, generating a set of policies S220, and/or any other suitable steps. Additionally, policy proposals in S200 can be determined based on decision criteria and reward functions, which may facilitate optimization around the proposals most likely to be favorably evaluated in S400 (e.g., in view of current environmental risks and/or the current risk profile).

The set of policy proposals can be determined based on a set of inputs (e.g., as determined by S100), which can include: the vehicle state, an environmental representation (e.g., a set of agents in the environment), route information (and/or a reward function associated therewith), policy selection criteria (e.g., reward function and/or cost function evaluated in S400, etc.), prior environmental risk (e.g., environmental risk profiles from a prior risk analysis; such as for each agent in a prior representation and/or prior risk analysis), and/or any other suitable set of inputs.

In a first set of variants, a first set of policy proposals can be predetermined and/or predefined for a particular driving context/region (e.g., highway; multi-lane roadway; etc.), such as according to a set of heuristics and/or predefined rules (e.g., a lookup table, etc.). For example, a set of fallback policies (e.g., emergency stop; evasive left; evasive right; etc.) can be considered as policy proposals at each election cycle. Additionally or alternatively, the set of fallback policies can be refined in S200 based on risk profiles in the environment. For instance, based on the risk profiles, S200 can propose exactly one evasive turn as a (fallback) policy proposal: either an evasive left or an evasive right. As a second example, a set of ‘ego-relative’ policies (e.g., coast in lane; shift and stop at shoulder; etc.) can be proposed at each election cycle, independently of any agents in the environment. However, another subset of predefined policies can be proposed in S200 and/or every fallback policy may be proposed at each election cycle.

In a second set of variants, nonexclusive with the first, a second set of (risk-aware) policy proposals can be determined based on the environmental representation and/or environmental risks associated therewith. For example, policies can be constructed/generated as a combination of policy elements (i.e., control laws, constraints, actions, etc.) which address agents and/or risks in the environment (e.g., as assessed in a prior iteration of S300). Policy elements can address individual agents, multiple agents (e.g., same or different type; all agents of a particular type; a series of parked cars), a single risk element, multiple risk elements, and/or any other suitable policy element(s). For instance, a first policy may direct the ego agent to cross a road centerline to navigate around a parked car along the curb of a narrow road, while a second policy may navigate past four cars parked along the curb (e.g., up to a point where there is sufficient clearance for opposing traffic flow).

In a third set of variants, S200 can include a combination of the first and second variants (e.g., where the first set of policy proposals and the second set of risk aware policy proposals are output by S200 for simulation and risk assessment in S300).

Selecting a set of policy elements S210 functions to determine a risk-aware set of behavioral options for the system to consider for policy proposition (e.g., in S220). S210 is preferably performed by the element selector 103 but can alternatively be performed by another suitable system component. S210 is preferably performed after receiving a risk profile (e.g., from a risk model in real time, from a prior iteration of the method, etc.) but can alternatively be performed at any other suitable time.

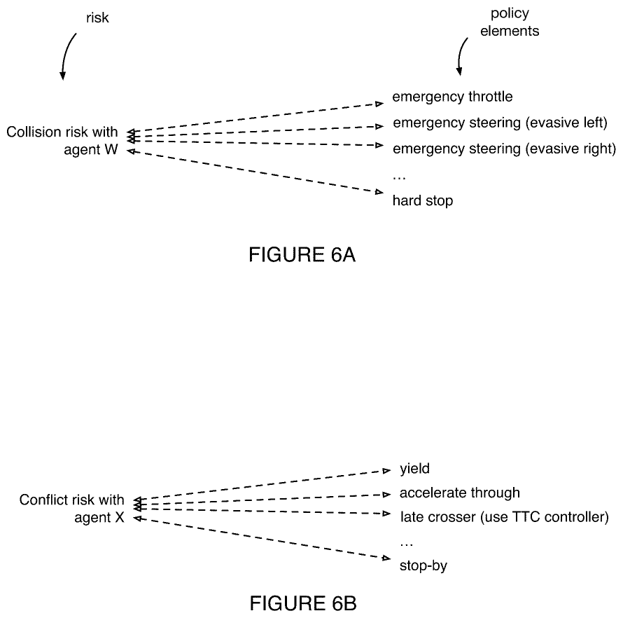

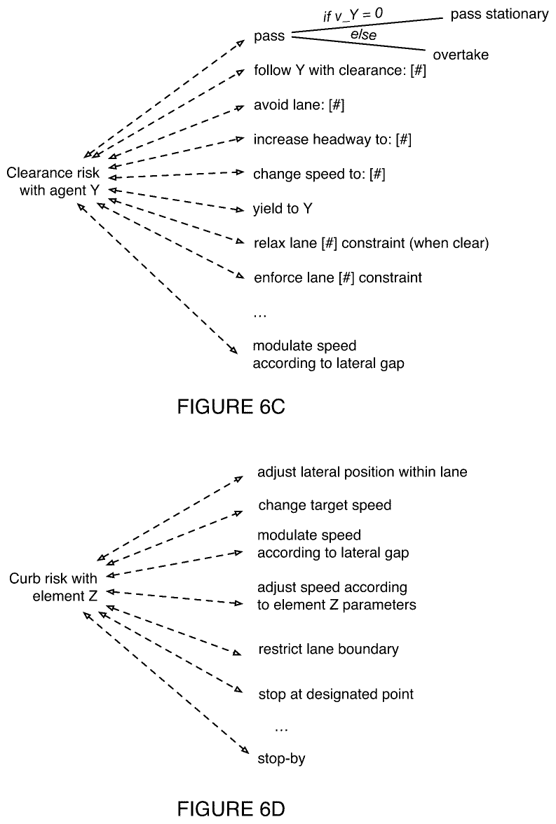

In a first variant, S210 can include a direct mapping approach, wherein specific risk classes are deterministically mapped to corresponding policy elements 111 (e.g., collision risks mapped to emergency braking elements, clearance risks mapped to lateral avoidance elements, conflict risks mapped to yielding elements, etc.). Examples of mappings between risks and policy elements (e.g., semantic action identifiers thereof, etc.) are shown in FIGS. 6A, 6B, 6C, and 6D. In this variant, the mapping can be predetermined or dynamically-determined. In a second variant, non-exclusive with the first, S210 can include a model-based approach, wherein a trained model (e.g., neural network, decision tree, machine learning classifier, etc.) receives risk profile data as input and outputs a set of policy elements based on learned associations between risk patterns and appropriate behavioral responses. In variants, the element selector can implement risk-to-element mappings such as: collision risks associated with emergency steering or emergency braking elements; conflict risks (e.g., time or space conflicts at intersections, etc.) associated with yielding elements or acceleration elements to clear conflict zones; clearance risks associated with lateral repositioning elements (e.g., lane shifting, passing, etc.) or longitudinal adjustment elements (e.g., following, speed modification, etc.); and infrastructure risks associated with path modification elements or stopping elements.

In variants, the set of policy elements can be ordered (e.g., as a sequence), partially ordered, or unordered. In variants, the set of policy elements can be associated with and/or ordered based on: risk metrics, temporal constraints and/or dependency relationships, priority weightings, computational complexity, resource requirements, and/or any other suitable ordering criteria.

In an illustrative example, a vehicle traveling along a road and iteratively performing the method (e.g., policy generation, simulation, and control) can observe a set of risks X. As the vehicle approaches a new environmental agent, the MPDM model 101 can detect a risk Y increasing in probability and decreasing in distance as the vehicle approaches. The risk Y is associated with a policy element which was previously not in the set of available policy elements to the vehicle (e.g., when the vehicle merely observed the set of risks X). As the vehicle approaches, risk Y and policy elements associated therewith are more likely to appear within simulated policy proposals and thus are more likely to define vehicle behavior (e.g., the “action space” of the vehicle can expand to include policy elements associated with risk Y, etc.). When the vehicle passes the environmental agent, risk Y may disappear (e.g., “fade”) from the sets of risks used to determine policy elements and the action space can contract to exclude policy elements associated with risk Y (e.g., as it is no longer as impactful on the simulations and risk metrics derived therefrom).

However, S210 can be otherwise performed.

Generating a set of policies S220 functions to combine policy elements into risk-aware policy proposals. S220 is preferably performed after S210 but can alternatively be performed at any other suitable time. S220 is preferably performed by the policy generator but can alternatively be performed by any other suitable system component.

In variants, S220 can include selecting a subset of policy elements from the set of selected policy elements, validating that the subset of policy elements are non-conflicting, and constructing a policy from the set of selected policy elements.

The policy generator can select subsets (e.g., combinations) of the available policy elements (e.g., the selected policy elements from S210, etc.), The available policy elements preferably include the selected policy elements from S210 but can additionally or alternatively include policy elements from prior iterations of S210 (e.g., from prior election cycles, to ensure behavioral consistency, etc.). Additionally or alternatively, generated policies from iterations of S220 at prior timesteps (e.g., a first policy and second policy determined during a prior election cycle, etc.) can be used directly. The number of policy elements which are selected in S210 can be predetermined or dynamically determined. In examples, the number of policy elements which are selected can be 1, 2, 3, 5, 10, 20, 40, 60, 80, 100, a number of policy elements within an open or closed range bounded by the aforementioned values, and/or any other suitable number of policy elements. The number of policy elements as a fraction of the available policy elements which are selected can be 1%, 5%, 10%, 25%, 50%, 60%, 80%, 100%, within an open or closed range bounded by the aforementioned values, and/or any other suitable fraction. The number of policy elements in each subset can be the same or different between subsets. Policy elements preferably overlap between subsets (e.g., by 10%, 25%, 50%, 75%, 90%, etc.) but can alternatively not overlap. In an example, a first set of policies can include a first set of constraints distinct from a second set of constraints of a second set of policies. The policy elements in the subset are preferably cotemporal (e.g., are competing elements which a policy seeks to reconcile at the same time, such as [avoid car to the left] and [avoid car to the right]) but can additionally or alternatively be non-cotemporal (e.g., sequential elements, such as [follow lane] and [stop at stop sign]). In examples, policy elements can be associated with a time and/or conditional relationship with other policy elements (e.g., performing a policy element only once another policy element has been implemented, etc.) or environmental conditions (e.g., performing a policy element associated with the vehicle reaching a stopping point indicated by a stop sign seen in advance, etc.). However, policy elements can have any other suitable temporal or conditional relationship with each other.

The process of selecting the subset of policy elements to be used for a policy proposal can be random or non-random. In a first variant, the subset of policy elements are selected according to risk parameters of risks associated with the policy elements. In an example of this first variant, a policy element which corresponds to a risk which is high severity may get priority in selection over a policy element which corresponds to a lower severity risk. In other examples of this first variant, the system can prioritize certain types of risk and/or adjust weights associated with certain types of risk to tune system behavior. In other examples of this first variant, other risk metrics (e.g., probability, proximity, closeness in time, etc.) may be used in addition or alternatively to weight or bias the selection of available policy elements. In a specific example, policy elements are selected according to a probability distribution of risks associated therewith (e.g., with policy elements associated with higher probability risks being more likely to be selected, etc.) In a second variant, policy elements associated with an elected policy from a previous timestep can be selected (e.g., as a predetermined subset of the final set of selected policy elements, etc.) and/or preferred. In a first specific example, the selection process can account for computational constraints by prioritizing policy elements which are both highly probable and occur earliest in the simulation timeline (e.g., during the simulation at S400, etc.). In a second specific example, the selection process can deprioritize policy elements which are associated with poorly-performing policies during simulation (e.g., from prior iterations of S400, etc.). In a third specific example, all subsets include a predetermined grouping of policy elements and/or policy elements associated with a predetermined risk class or environmental agent.

In a variant, selection of policy elements can occur such that some risks in the risk profile are not associated with any of the policy elements in the subset. In this variant, the resultant subset of policy elements and/or resultant proposed policy can be determined independently of such risks. In other variants, however, all risks within the risk profile correspond to at least one policy element.

In variants, selection of policy elements can include determining an ordering of policy elements (e.g., wherein the subset of policy elements is a temporal and/or logical sequence, etc.). In an example, the ordering is based on an ordering of policy elements. (e.g., determined in S210). However, the subset of policy elements and/or a portion thereof can alternatively not be ordered.

In variants, selection of policy elements can be performed with replacement (e.g., such that a policy element within the subset of policy elements is a duplicate. However, selection of policy elements can alternatively be performed without replacement and/or otherwise be performed.

In variants, selection of policy elements can be performed based on risk metrics (e.g., risk location, risk time within the planning horizon, risk probability, risk severity, and/or any other suitable risk metrics). For example a policy element associated with a higher number or risks or risks with higher severity can be prioritized. However, selection of policy elements can alternatively not be based on risk metrics. However, selection of the subsets of policy elements can be otherwise performed.

However, some policy elements are mutually exclusive and cannot be combined sensibly—for example, attempting to both follow and overtake the same agent would produce incoherent behavior. As such, subsets of policies can optionally additionally be refined or filtered according to any suitable set of rules, heuristics, predetermined (deterministic) constraints (i.e., pertaining to roadway rules; mutual exclusivity; physics; etc.), and/or can be otherwise filtered for compatibility. As an example, it may be invalid to combine a policy of changing lanes to the left and changing lanes to the right, since these policies are mutually exclusive. Likewise, it may be invalid to follow a first agent while passing a second agent. Thus, the policies are preferably constructed from (all) valid combinations of policy elements (i.e., control laws). In an example, each policy element is compared against all other policy elements in a subset, and when a conflicting set (e.g., pair) of policy elements are detected, the whole subset can be discarded (e.g., the set of policy proposals can be “pruned”) and/or one or both of the conflicting set of policy elements are removed (e.g., the subset of policy elements can be “pruned”). In another example, a validation process can leverage a compatibility matrix or rule set that encodes which policy element combinations are physically realizable and behaviorally coherent. However, the policy elements of each subset can be otherwise refined.

Each constructed policy proposal preferably includes policy elements that define both lateral and longitudinal behaviors but can alternatively include policy elements that define one or none of lateral and longitudinal behavior. In variants, the lateral policy elements can translate into a modification of the vehicle's path (e.g., shifting away from obstacles, changing lanes), determination of a lateral offset from a reference path, and/or any other suitable lateral behavior. In variants, longitudinal policy elements can translate to a speed adjustment, a following distance definition, a change in a reference agent for following, a stopping point, and/or any other suitable longitudinal behavior. In a variant, when no lateral modifications are proposed, the vehicle can default to following the center of the lane.

Each constructed policy proposal preferably includes a reference path but can alternatively not include a reference path. In variants, reference paths can differ or be the same between different policy proposals. The policy elements may also incorporate temporal or spatial constraints derived from the risk assessment into a resultant policy proposal, such as “exit this lane within 20 meters” or “clear this position before the risk materializes in 8 seconds. In a first variant, all policy proposals in a set include a reference path. In a second variant, no policy proposals in a set include a reference path. In a third variant, a strict subset of policy proposals in a set include a reference path (e.g., wherein the presence of a reference path is based on a policy type, etc.). However, policy proposals can otherwise include or not include reference paths.

In a first specific example, a “pass stationary obstacle” element may define a lateral offset cost function for a trajectory determination algorithm. In a second specific example, a “restrict lane boundary” element may add constraints to keep the vehicle from encroaching into an oncoming lane while performing an evasive maneuver on a different environmental object. However, policy elements can otherwise translate to policy proposal components.

In variants in which policy elements include constraints (e.g., predefined, deterministic constraints, etc.) the policy proposals determined by the policy generator preferably satisfy the constraints of policy elements from which the policy proposal is determined.

In variants, the resultant set of policy proposals can be further refined (e.g., to include policies which are less risk producing, policies which minimize jerk and/or acceleration, policies which satisfy a reward function of the simulation, etc.). The policy generator can output this fuzzy optimization given the set of inputs and/or a cost function (e.g., which can be the same as may be evaluated in S400, or different), via the policy generator. As an example, S220 can include using a classically programmed heuristic optimization which selects the best N policy proposals satisfying a set of optimization constraints (e.g., below a predetermined risk threshold). As a second example, S220 can include generating a set of policy proposals (e.g., control laws for a particular path) by any one or more of: regression, neural networks, ensemble methods, optimization methods, heuristics, equations, Bayesian methods, support vectors, statistical methods (e.g., based on risk probability), fuzzy logic, comparison methods, deterministics, genetic programs, and/or any other suitable methods or model elements.

The resultant proposed policies are preferably determined based on non-overlapping policy elements but can additionally or alternatively be determined based on overlapping policy elements.

However, risk aware policies can be otherwise determined.

However, policy proposals can be otherwise determined and/or any other suitable set of policies can be considered, simulated, and/or assessed in S300.

### 4.3 Method—Determining and Assessing a Set of Risks Encounterable by the Ego Vehicle S300

The method includes determining and assessing a set of risks encounterable by the ego vehicle S300, which functions to perform any or all of: detecting the potential hazards that the ego vehicle may encounter in the future, determining whether or not (and/or when) these potential hazards pose a current or future risk, and determining whether or not the potential hazards could be avoided (e.g., by the ego vehicle, by other vehicles or entities in an environment of the ego vehicle, etc.). S300 further preferably functions to inform how a vehicle is operated in S400. Additionally or alternatively, S300 can perform any other suitable functions. S300 is preferably performed in response to and based on the information received in S100 and/or S200, but can additionally or alternatively be performed at any other suitable times and/or based on any suitable information.

S300 preferably includes performing a set of simulations S310 (e.g., as shown in FIG. 3), which functions to enable risks which could occur in the future to be detected and further characterized (e.g., in S320). The set of simulations preferably includes forward simulations, which examine future scenarios (based on forward stepping in time) for the ego vehicle and objects (e.g., other vehicles, pedestrians, etc.) in its environment, such as in an event that the ego vehicle (and/or other vehicles) performs a certain policy (e.g., behavior, action, etc.). In variants, different simulations of the set of simulations can include different proposed policies, such that the impacts of election of different policies can be predicted (e.g., via risk metrics, a cost function, etc.). In variants, the set of simulations can include can include multiple simulations for each proposed policy (e.g., wherein between such multiple simulations, the policies assigned to other agents in the scene [representing the objectives of other agents] differ, etc.) Additionally or alternatively, the simulations can be otherwise suitably performed.

In a preferred set of variations, any or all simulations are performed within (e.g., during, as part of, etc.) a multi-policy decision-making process (e.g., as described above, as implemented during a planning/election cycle of the ego agent, etc.), such any or all of those described in U.S. application Ser. No. 16/514,624, filed 17 Jul. 2019, and/or U.S. application Ser. No. 17/365,538, filed 1 Jul. 2021, each of which is incorporated herein in its entirety by this reference. Alternatively, the simulations can be performed in accordance with a different decision-making process, performed absent of and/or asynchronously with a multi-policy decision-making process (e.g., during a trajectory generation and/or trajectory modification phase, during a path planning process, etc.), and/or at any other time(s).

In a set of examples, for instance, a set of simulations (e.g., including each simulation type) is performed for each policy proposal determined at S200.

The set of simulations preferably includes multiple types of simulations, wherein the multiple types of simulations function to collectively provide accurate, robust assessments of risks and/or features of the risks (e.g., likelihood, characterization, etc.) which may occur in the future. The multiple simulation types can be simulated: in parallel, in series, and/or any combination. Alternatively, simulations of a single type and/or any other types of simulations can be performed in S210. For example, the set of simulations can include any type(s) of simulations as disclosed in U.S. application Ser. No. 16/514,624, filed 17 Jul. 2019; and U.S. application Ser. No. 17/365,538, filed 1 Jul. 2021; each of which is incorporated in its entirety by this reference. Additionally or alternatively, the set of simulations can include any other simulations and/or types of simulations.

S300 further preferably includes analyzing the simulation results S320, which functions to detect, characterize, and/or quantify any or all of the risks encounterable by the vehicle and/or environmental agents in an environment of the vehicle (e.g., other vehicles, pedestrians, cyclists, etc.). The outputs of this analysis preferably include a set of metrics which can be used in decision-making (e.g., policy selection for a current election cycle at timestep T; risk-aware policy determination in a subsequent election cycle at timestep T+1; etc.) of the ego vehicle (e.g., in S400), but can additionally or alternative be used to trigger further analyses (e.g., reward analyses) and/or otherwise be suitably used. In preferred variations, for instance, S320 functions to inform the operation of the vehicle in S400 (e.g., determine whether or not the vehicle needs to respond to the risk immediately, determine whether or not the risk can be avoided, etc.). Additionally, risk analyses and/or environmental risk data can be used as an input for subsequent iterations of S200 (e.g., for a subsequent election cycle at timestep T+1, etc.), which can be used for risk-aware policy generation (and/or policy proposal determinations) in subsequent election cycles.

However, simulation and/or risk analyses can be otherwise used.

Analyzing the simulation results preferably includes determining if a potential risk (e.g., potential hazard event) is encounterable by the ego vehicle (and/or environmental objects) in the future. Potential risks are preferably identified based at least on the results of a simulation(s) from S310. Additionally or alternatively, S320 can further include characterizing a type of potential risk (e.g., collision, near-miss of a collision, collision involving a fatality vs. injury vs. property damage, property damage, violation of traffic rules, etc.) and/or an anticipated severity of the potential risk.

Determining if a potential risk has been detected and/or characterizing the potential risk and/or its severity is preferably performed based on the calculation of a set of risk metrics (e.g., risk probability, risk severity, etc.). In a preferred set of variations, risk severity can be detected and/or characterized through the calculation of a set of energy and/or work metrics, which represent the amount of energy that could result from behavior of the ego vehicle and/or the amount of and/or work that would be required by the ego vehicle and/or environmental agents to prevent that event and/or respond to that event (e.g., slowing down to prevent a collision, stopping because a collision ahead has impeded its path, etc.). The risk severity metric is preferably determined based on an energy metric, such as a kinetic energy and/or a modified (e.g., weighted, scaled, etc.) version of kinetic energy (e.g., derivative of velocity, velocity-squared, velocity-squared multiplied by a scaling factor, velocity-squared multiplied by mass and/or a scaling factor, kinetic energy without mass, etc.), where the energy metric represents—such as in the event of collision—the energy produced by the impact of the collision. In some variations, for instance, the risk severity metric includes any calculated kinetic energy metrics aggregated with any work metrics occurring in the scenario. In some examples, for instance, the simulation can show how if the ego vehicle engages in an overly conservative behavior immediately (e.g., stops immediately because a potential collision may occur), it might actually increase the overall total energy of the system (e.g., due to the amount the ego vehicle would have to brake, due to the amount of work other vehicles would have to spend in stopping because of the ego vehicle stopping, etc.) more than a potential hazardous event (e.g., ego vehicle hitting a curb).

Risk metrics can optionally be scaled and/or weighted with any number of scaling factors (e.g., during S300, during S210, during S220, etc.), such as those which indicate a level of potential harm resulting from the potential hazardous event. For instance, the scaling factors can increase the magnitude of the risk metric for a collision of the ego vehicle with a pedestrian, which would have a higher likelihood to cause harm as compared with a collision between an ego vehicle and a more rigid object (e.g., other vehicle, static object, etc.). In examples, for instance, an object softness (e.g., produced through a classification of the object with the ego vehicle's perception subsystem) and/or object human-ness (e.g., pedestrian, vehicle with a pedestrian, biker, number of anticipated humans involved, etc.) can be used to scale the risk metric (e.g., modified kinetic energy metric). Additionally or alternatively, any other features or information can be used to scale the energy metric, such as, but not limited to: a type of predicted impact, a location of a predicted impact (e.g., rear-end collision, head-on collision, etc.), and/or any other features.

S320 further preferably includes determining whether or not a detected potential hazardous event can be prevented and/or mitigated (e.g., reasonably prevented), such as through one or more actions of the other environmental objects and/or the ego vehicle. This functions to determine whether or not the ego vehicle needs to respond to the potential risk immediately, or if there is time to wait and see how the environment evolves (e.g., how the environmental objects behave).

Determining if a potential hazardous event can be prevented and/or mitigated preferably includes calculating the value of a work metric (e.g., work, force multiplied by displacement, modified work, scaled and/or weighted work, relative work, etc.) that would need to be exerted by/performed by environmental objects and/or the ego vehicle, individually and/or collectively (e.g., by all environmental agents, by all environmental agents and the ego vehicle, etc.), in order to prevent the identified event from occurring. The work metrics preferably have the same units as the energy metrics (e.g., as described above), such that the work and energy metrics can be any or all of: aggregated, compared, and/or otherwise used. Based on these calculations of work, other parameters—such as those related to control commands of vehicles and/or temporal parameters—can be calculated and compared with thresholds (e.g., predetermined thresholds, class-label-specific thresholds, etc.) in order to determine how feasible it would be for the identified event to be avoided.

In a preferred set of variations, for instance, in an event that a potential hazardous event is detected, the amount of work required by each of the involved objects (e.g., environmental agents, ego vehicle, etc.) to avoid the hazardous event is calculated. Based on these work metrics, a level of braking required to perform this amount of work can be calculated for each of the involved vehicles (e.g., cars, bikes, etc.) and compared with one or more braking thresholds (e.g., braking force, braking magnitude, etc.) to determine if and/or to what extent it would be possible for the vehicles to stop and avoid the event (e.g., wherein if the level of braking is below a predetermined threshold it is determined that the vehicle could stop, wherein if the level of braking is above a predetermined threshold it is determined that the vehicle could not stop, etc.). Additional or alternative to a braking level, any other metrics can be calculated, such as, but not limited to: a braking rate, a braking distance, a stopping distance, an acceleration and/or deceleration rate, a response time (e.g., to be compared with average human response times), the effect of changing heading (e.g., whether or not it would be possible to swerve to avoid an event), and/or any other metrics.

The amount of work can optionally be calculated in a relative fashion, such as a difference between work in a 1^{st} subset of simulations (e.g., including the ego-vehicle) and work in the 2^{nd} subset of simulations (e.g., excluding the ego-vehicle), and/or in any other ways.

S320 can optionally include aggregating the energy metrics and the work metrics, such as to calculate an overall energy associated with a potential hazardous event (e.g., kinetic energy of a collision aggregated with the amount of work that vehicles not involved in the collision would need to exert to stop or slow down due to the collision). Further additionally or alternatively, any or all metrics can be aggregated with and/or compared in S220. Additionally or alternatively, determining if a potential hazardous event can be prevented can include comparing energy and/or work metrics (e.g., modified kinetic energy, relative modified kinetic energy, work, aggregated work and energy, etc.) with one or more predetermined thresholds, and/or any other processes.

S320 can optionally include discounting any or all metrics (e.g., energy metrics, work metrics, overall cost metric, etc.) in response to determining that the potential hazardous event can be avoided (e.g., by actions of the ego vehicle, by actions of environmental agents, by actions of the ego vehicle and environmental agents, etc.). This functions to discount the risk (e.g., not respond to the risk immediately, wait for additional information, etc.) in the ego vehicle's decision-making. Additionally or alternatively, S320 can include otherwise triggering an outcome which is used in the ego vehicle's decision-making.

In a set of examples for instance, in an event that it is determined that the risk is close enough in the future that it cannot be avoided and/or cannot be avoided in an acceptable way (e.g., according to a set of criteria and/or thresholds), the risk will persist in the vehicle's decision-making (e.g., in S400, becoming a huge negative score such that the ego vehicle will not select the associated policy that results in the risk unless it is the best case risk [e.g., lowest modified kinetic energy] from policies that all result in risk, etc.), and in an event that the risk is determined to be far enough away in the future for the ego vehicle and/or environmental objects to respond (e.g., in an acceptable way), the risk can be ignored and/or down-weighted in the vehicle's decision-making (e.g., thereby preventing the ego vehicle from engaging in an overly conservative and/or premature behavior).

In variants, simulation results and/or risks can optionally be aggregated and/or post-processed by a risk model(s) 102 to generate a risk profile(s) (e.g., to facilitate subsequent risk-aware policy selection via S200; an example is shown in FIG. 2). Risk profiles can be associated with any combination(s) of individual policies and/or a subset of policy elements and control laws thereof, one or more environmental agents within the environment, and/or any other suitable environmental risks. Alternatively, subsequent iteration(s) of S200 can directly utilize the risk assessments of S300 to facilitate risk-aware policy determinations, and/or risks can be otherwise assessed/processed.

Additionally or alternatively, S300 can include any other processes and/or be otherwise suitably performed. Additionally, S300 can include any and/or all of the methods and/or process elements for determining and assessing a set of risks encounterable by the ego vehicle as described in U.S. application Ser. No. 18/538,312, filed 13 Dec. 2023, which is incorporated herein in its entirety by this reference.

### 4.4 Method—Operating the Ego Vehicle Based on the Assessed Risks S400

The method can optionally include operating the ego vehicle based on the assessed risks S400, which functions to optimally respond to the risks based on the risk features characterized in S200. Additionally or alternatively, S400 can perform any other functions. S400 can be performed during a multi-policy decision-making process of the ego vehicle (e.g., as described above), but can additionally or alternatively be performed in accordance with any other decision-making processes of the ego vehicle. In preferred variations, for instance, S300 includes selecting a policy from a set of policy options for the ego vehicle based on the assessed risks resulting from the set of simulations performed for each of the policy options.

S400 can optionally include calculating a reward metric, which functions to assess how much the ego vehicle would progress toward a goal (e.g., reduce its distance to a destination, obey traffic rules, etc.), which can optionally be incorporated in the decision-making (e.g., policy selection) of the ego vehicle. In a first set of variations, the decision-making in S400 is performed in a hierarchical (e.g., decision tree) fashion, wherein a reward metric is only calculated in an event that no risks are detected in S300 and/or any risks detected in S300 can be avoided. In a set of examples, in an event that no potential hazardous event is detected, other lower tiers of events (e.g., legal risk events, comfort risk events, delay risk events, etc.) can be considered (e.g., prior to a reward metric). In a second set of variations, a reward metric can be aggregated with one or more risk metrics (e.g., total energy, modified kinetic energy, modified kinetic energy aggregated with work, etc.) to determine an overall score for each policy.

S400 preferably includes selecting a policy (e.g., action, behavior, etc.) for the ego vehicle based on the risk and/or reward metrics and maneuvering the vehicle according to that policy. This can include, for instance, assessing the risk over the whole simulation/policy rollout (e.g., 8 seconds), such as aggregating risks over all time steps, discounting risks at future time steps if objects can brake sufficiently or otherwise avoid the risk, pushing risks farther into the future (e.g., by slowing down), and/or otherwise analyzing risk. For instance, S400 can leverage the different simulation rollouts to estimate if the likelihood of a conflict is increasing or decreasing based on what the ego vehicle is doing or planning to do (e.g., by referencing historical rollouts and analyzing if the risk is going up or down), and selecting a policy based on that (e.g., changing to a new policy if the risk continues to increase with the same policy, maintaining a same policy if the risk continues to decrease, etc.). In variants in which a policy includes a vehicle controller, a set of constraints, and/or any other suitable control functionality, such control functionality can be implemented in S400. In variants, switching between policies entails switching between vehicle controllers.

Additionally or alternatively, risk can be otherwise suitably compared and selected from different policy proposals (e.g., an example is shown in FIG. 2). Additionally or alternatively, S400 can include any other suitable processes.

The method can additionally or alternatively include any other processes, such as, but not limited to, any or all of: repeating any or all of the above processes (e.g., to see if an avoidable risk evolves into an unavoidable risk, to see if an avoidable risk goes away, etc.), and/or any other suitable processes.

All or portions of the method can be performed in real time (e.g., responsive to a request), iteratively, concurrently, asynchronously, periodically, and/or at any other suitable time. All or portions of the method can be performed automatically, manually, semi-automatically, and/or otherwise performed.

All or portions of the method can be performed by one or more components of the system, using a computing system, using a database (e.g., a system database, a third-party database, etc.), by a user, and/or by any other suitable system. The computing system can include one or more: CPUs, GPUs, custom FPGA/ASICS, microprocessors, servers, cloud computing, and/or any other suitable components. The computing system can be local, remote, distributed, or otherwise arranged relative to any other system or module.

Different subsystems and/or modules discussed above can be operated and controlled by the same or different entities. In the latter variants, different subsystems can communicate via: APIs (e.g., using API requests and responses, API keys, etc.), requests, and/or other communication channels.

Alternative embodiments implement the above methods and/or processing modules in non-transitory computer-readable media, storing computer-readable instructions that, when executed by a processing system, cause the processing system to perform the method(s) discussed herein. The instructions can be executed by computer-executable components integrated with the computer-readable medium and/or processing system. The computer-readable medium may include any suitable computer readable media such as RAMs, ROMs, flash memory, EEPROMs, optical devices (CD or DVD), hard drives, floppy drives, non-transitory computer readable media, or any suitable device. The computer-executable component can include a computing system and/or processing system (e.g., including one or more collocated or distributed, remote or local processors) connected to the non-transitory computer-readable medium, such as CPUs, GPUs, TPUS, microprocessors, or ASICs, but the instructions can alternatively or additionally be executed by any suitable dedicated hardware device.

Embodiments of the system and/or method can include every combination and permutation of the various system components and the various method processes, wherein one or more instances of the method and/or processes described herein can be performed asynchronously (e.g., sequentially), contemporaneously (e.g., concurrently, in parallel, etc.), or in any other suitable order by and/or using one or more instances of the systems, elements, and/or entities described herein. Components and/or processes of the following system and/or method can be used with, in addition to, in lieu of, or otherwise integrated with all or a portion of the systems and/or methods disclosed in the applications mentioned above, each of which are incorporated in their entirety by this reference.

As a person skilled in the art will recognize from the previous detailed description and from the figures and claims, modifications and changes can be made to the preferred embodiments of the invention without departing from the scope of this invention defined in the following claims.

We claim:

1. A method for controlling a vehicle, comprising:
during a first time period:
sampling a first set of measurements of a set of environmental objects; and
based on the first set of measurements, determining a set of risks associated with the set of environmental objects; and
during a second time period:
based on the set of risks, determining a plurality of actions;
determining a first combination of actions from the plurality of actions;
determining a second combination of actions from the plurality of actions, wherein presence of at least one action differs between the first combination and the second combination;
determining a first set of vehicle control policies according to the first combination of actions;
determining a second set of vehicle control policies according to the second combination of actions;
sampling a second set of measurements of the set of environmental objects;
based on the second set of measurements:
performing a set of first forward simulations of the set of environmental objects according to the first set of vehicle control policies; and
performing a set of second forward simulations of the set of environmental objects according to the second set of vehicle control policies;
based on a comparison of the set of first forward simulations and the set of second forward simulations, selecting the first set of vehicle control policies; and
controlling the vehicle according to the first set of vehicle control policies.

2. The method of claim 1, wherein determining the set of risks comprises aggregating metrics from multiple simulations of the set of environmental objects, wherein the multiple simulations are performed during a same policy election cycle.

3. The method of claim 1, wherein the set of risks includes a first risk identified at a first timestep and a second risk identified at a second timestep distinct from the first timestep.

4. The method of claim 1, wherein the plurality of actions are determined based on a predetermined mapping between each risk and a respective set of actions.

5. The method of claim 1, wherein determining the first combination of actions comprises amending the first combination of actions such that the actions of the first combination are compatible.

6. A method for controlling a vehicle, comprising:
determining a set of risks, each risk associated with at least one object of a set of objects in an environment of the vehicle;
based on the set of risks, selecting a plurality of actions from a predetermined set of actions;
from the plurality of actions, selecting a first combination of actions and a second combination of actions, wherein the first combination of actions and second combination of actions are different;
based on the first combination of actions, constructing a first set of policies for controlling the vehicle;
simulating the first set of policies applied to the set of objects in the environment;
determining a first set of metrics associated with the first set of policies;
based on the second combination of actions, constructing a second set of policies for controlling the vehicle;
simulating the second set of policies applied to the set of objects in the environment;
determining a second set of metrics associated with the second set of policies;
based on a comparison of the first set of metrics and second set of metrics, selecting the first set of policies; and
controlling the vehicle according to the first set of policies.

7. The method of claim 6, wherein the set of risks are determined using a forward simulation of the vehicle implementing a set of policies determined at a prior timestep.

8. The method of claim 7, wherein the set of risks are determined by aggregating metrics from a plurality of distinct forward simulations of sets of policies.

9. The method of claim 8, wherein the first set of policies and second set of policies are determined at the prior timestep.

10. The method of claim 7, wherein the set of risks include risks identified at multiple different timesteps.

11. The method of claim 6, wherein the first combination of actions comprises a set of semantic action identifiers with a predetermined mapping to types of risks included in the set of risks, wherein selecting the first combination of actions comprises using the predetermined mapping.

12. The method of claim 6, wherein the first combination of actions is determined independently of a subset of risks within the set of risks.

13. The method of claim 6, wherein the first simulation comprises multiple iterations of simulation using the same first set of policies, wherein behavior of another agent in the environment differs between simulations of the multiple iterations of simulation.

14. The method of claim 6, wherein selecting the first combination of actions comprises determining a compatibility of actions within the first combination of actions.

15. The method of claim 6, wherein the first set of policies is determined independently of a subset of risks within the set of risks.

16. The method of claim 6, wherein determining the set of risks comprises estimating a kinetic energy associated with avoiding a collision.

17. The method of claim 6, wherein a first risk of the set of risks is a risk associated with a conflict zone in the environment, wherein the first risk is associated with:
a location of the conflict zone;
a future time of reaching the conflict zone;
an estimated probability of the risk; and
an estimated severity of the risk.

18. The method of claim 17, wherein selecting the first combination of actions comprises using information selected from a set consisting of:
the location of the conflict zone;
the future time of reaching the conflict zone;
the estimated probability of the risk; and
the estimated severity of the risk.

19. The method of claim 6, wherein the first set of policies comprises a first set of constraints distinct from a second set of constraints of the second set of policies.

20. The method of claim 6, wherein the first set of policies comprises a vehicle controller.
